(19) United States
(12) Patent Application Publication
(10) Pub. No.: US 2011/0270710 A1
(43) Pub. Date: Nov. 3, 2011

(54) System for dynamically generating affiliate advertising within electronic communications

(76) Inventor: Anthony Nash, Beckenham (GB)

(21) Appl. No.: 12/799,676

(22) Filed: Apr. 30, 2010

(51) Int. Cl. G06Q 30/00; G06F 15/16

(52) U.S. Cl. 705/27.1; 709/206; 705/1.1

(57) ABSTRACT

A system and method with a distributor physically acting upon a computer to send an electronic mail message to a recipient. The system uses an Internet browser add-on to identify the presence of an electronic mail message and insert a predetermined advertising code into the electronic mail message. The advertising code can be generally selected by the system or selected by the distributor. Once selected, the advertisements are associated within the server with the distributor as part of an affiliate marketing program.

TECHNICAL FIELD

The present disclosure relates in general to a system for adding affiliate marketing material to electronic communications and, more particularly, to a system for automatically inserting affiliate marketing material into electronic mail messages in a web mail client.

### BACKGROUND

Electronic communications such as electronic mail message have been used for many years to deliver advertising messages to consumers. As most such advertisements are unrelated to the consumer's needs, a large number of electronic mail advertisements must be sent to obtain a single positive response. Consumers therefore receive thousands of useless advertisements for every one of interest. In response, consumers have adopted systems for filtering such useless advertising messages. Most advertising electronic mail messages are filtered from trusted senders and discarded before ever reaching their intended recipient.

Affiliate marketing programs are also known in the art. Such programs typically pay affiliates a commission, based upon a recipient clicking on a hyperlink to a commercial website and making a purchase or performing some other defined action on such a website. While such affiliate marketing programs are well known and generate a substantial amount of income, one drawback associated with such programs is that the advertising presented to the potential customer is not tailored to their needs or interests. Accordingly, even if a large number of potential customers visit the website, only a small fraction actually perform a commission rewarded action and generate income for the affiliate.

Another drawback of affiliate marketing programs is that if the advertisement is not tailored to the potential customer's needs, the affiliate hyperlink appears to be obtrusive advertising, undermining the overall experience of an affiliate's website, as opposed to a specifically tailored advertisement which would increase the website experience for the potential customer.

Yet another drawback associated with prior art affiliate marketing programs is that the affiliate often has little control over the advertising being forwarded. Random advertisements are less likely to generate a favorable response, increasing the need for a larger recipient pool, decreasing revenue, and upsetting recipients not interested in receiving such advertisements. If instead, the advertisements were matched with recipients most likely to generate a positive recipient response, this would not only decrease the necessary size of the recipient pool, but it would increase revenue for both the advertiser and the affiliate, and reduce the likelihood that a recipient would find the advertisement intrusive.

Still another drawback associated with the prior art is the time and energy associated with adding affiliate marketing materials to electronic communications. If the marketing materials are to be tailored to a specific recipient, this requires additional time and attention. It would, therefore, be desirable to combine the best attributes of electronic mail advertising and affiliate marketing advertising with advertisements more specifically tailored to the interests of the targeted recipients and automatically inserted them into electronic communications such as electronic mail messages. The difficulties encountered in the prior art heretofore are substantially eliminated by the present disclosure.

### SUMMARY OF THE DISCLOSED SUBJECT MATTER

This summary is provided as a simplified general introduction to selected concepts that are described in more detail below. This summary is not intended as a comprehensive identification of the key features or essential elements of the subject matter claimed below. This summary is also not intended to be used in determining the scope of the claimed subject matter.

The disclosed subject matter relates to an electronic communication system connecting a server, distributor and recipient across a network such as the Internet. The disclosed subject matter also relates to software that extends an Internet browser's functionality known as an add-on. The distributor first downloads this add-on and installs it for their particular browser. The distributor uses this browser to access a web mail client to prepare an electronic communication, such as an electronic mail message. The add-on, which binds to the browser at runtime, identifies the electronic mail message and inserts a predetermined affiliate code, which may be HTML, into the electronic mail message to display an advertisement. The affiliate code is selected by the system. This advertisement is associated within the server with the distributor as part of an affiliate marketing program.

When the recipient receives and opens an electronic mail message from the distributor, the affiliate code, which may be HTML, displays the predetermined advertisement, selected from the categories chosen by the distributor, within the electronic mail message.

When the recipient clicks on a hyperlink associated with the advertisement, the affiliate network server identifies the distributor from a unique identification parameter of the URL associated with the hyperlink and identifies the advertisement from a unique advertisement identification parameter also in the URL. The server then determines which advertiser's website to redirect the recipient to, and, by setting a cookie or query string parameters in the advertiser's URL, the recipient's activity can be identified on the advertiser's website and associated with the distributor for payment.

If the recipient registers with the website, makes a purchase, fills out a survey or performs some other predetermined action on the advertiser's website, the server may use the cookie or the identification parameters of the query string to compensate the distributor for that predetermined action.

### BRIEF DESCRIPTION OF THE DRAWINGS

The present disclosure will now be described, by way of example, with reference to the accompanying drawings in which:

FIG. 1 illustrates a block diagram of a system embodying the subject matter of the disclosure;

FIG. 2 illustrates a webpage used by a distributor to register;

FIG. 3 illustrates a flow chart of a process of downloading a browser add-on;

FIG. 4 illustrates an exemplary web client electronic mail message incorporating HTML code within the signature field;

FIG. 5 illustrates a flow chart of a process of adding advertising code to an electronic mail message with a browser add-on;

FIG. 6 illustrates a flow chart of a process for automatically inserting affiliate code into an electronic mail message using a browser add-on;

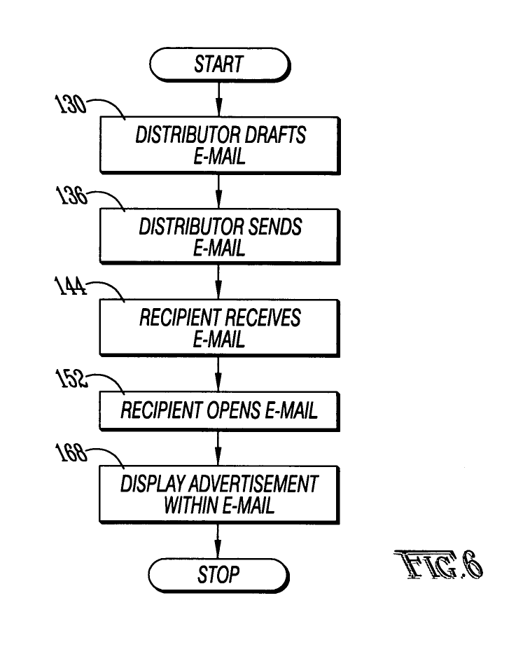

FIG. 7 illustrates an exemplary electronic mail message received by a recipient and displaying a dynamically generated advertisement associated with the affiliate code;

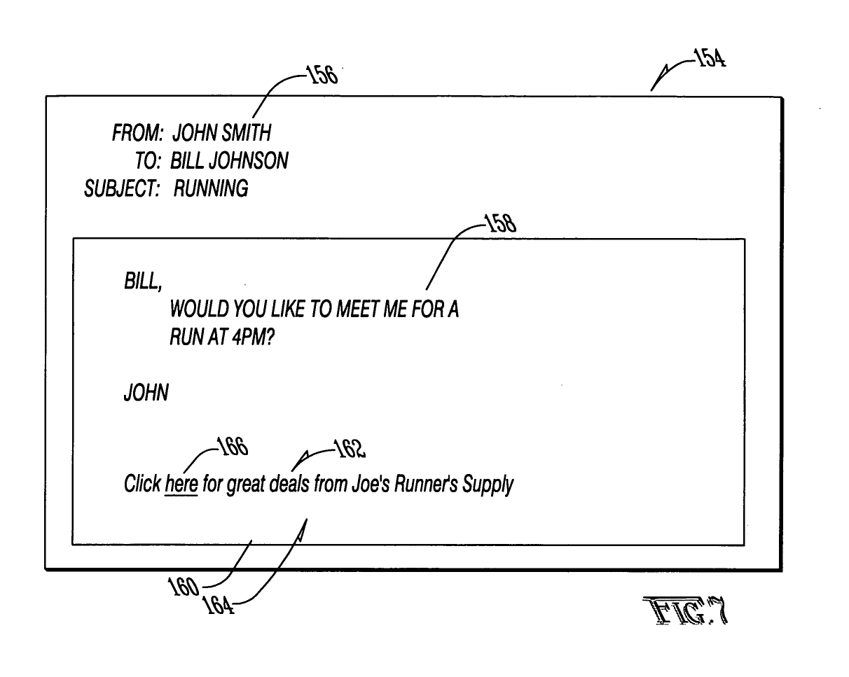

FIG. 8 illustrates a flow chart of a process for redirecting a recipient to an advertiser's website if that recipient clicks on a received advertisement; and

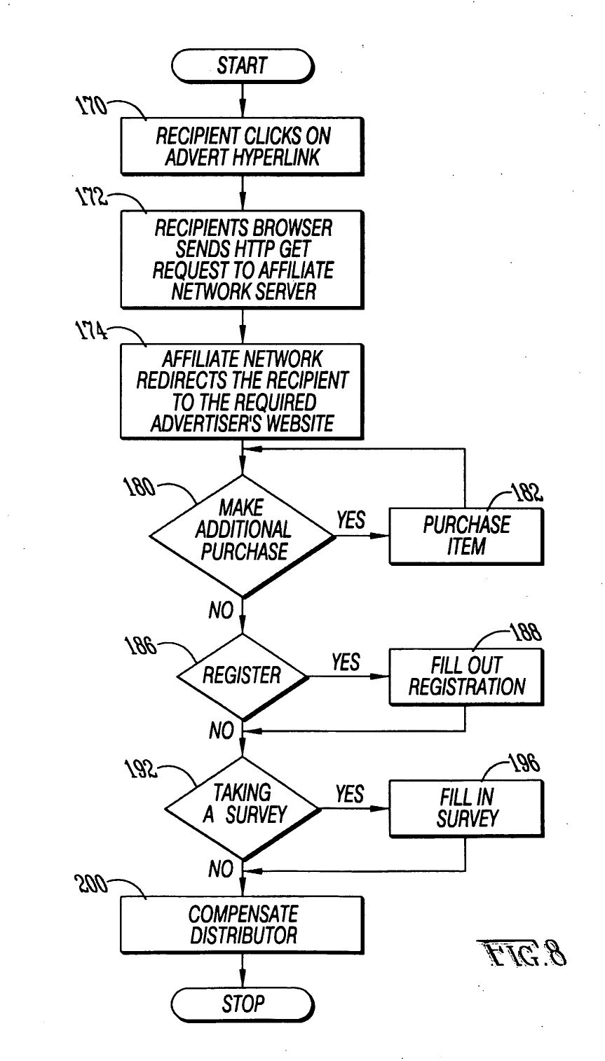

FIG. 9 illustrates an advertiser's website.

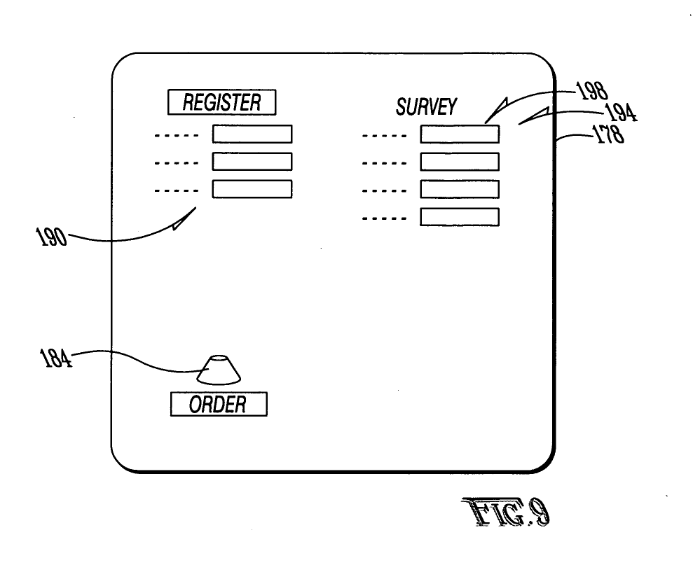

### DETAILED DESCRIPTION OF THE DRAWINGS

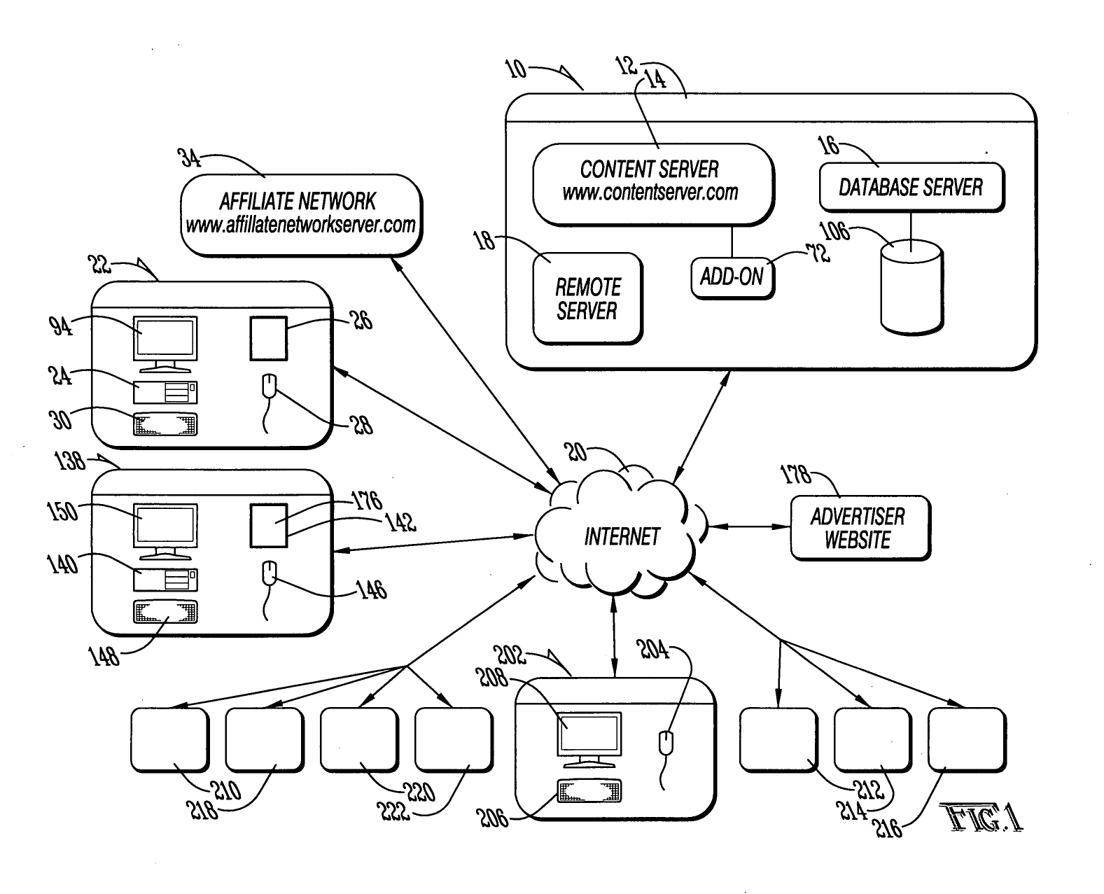

The claimed subject matter will now be described with reference to the drawings, wherein like numerals represent like elements throughout. The present subject matter relating to a system and method for automatically adding affiliate marketing material to electronic mail messages in a web mail client is shown generally as (10) in FIG. 1. The networked system (10) includes a server system (12), which itself includes processors, such as content servers (14), and database servers (16). The networked system (10) also includes a remote server (18). The servers (14) and (16) and (18) may be of any type known in the art, and are coupled to a network which, in the preferred embodiment, is the Internet (20). The servers (14) and (16) and (18) may have both internal and external storage mechanisms to manipulate information and to process information.

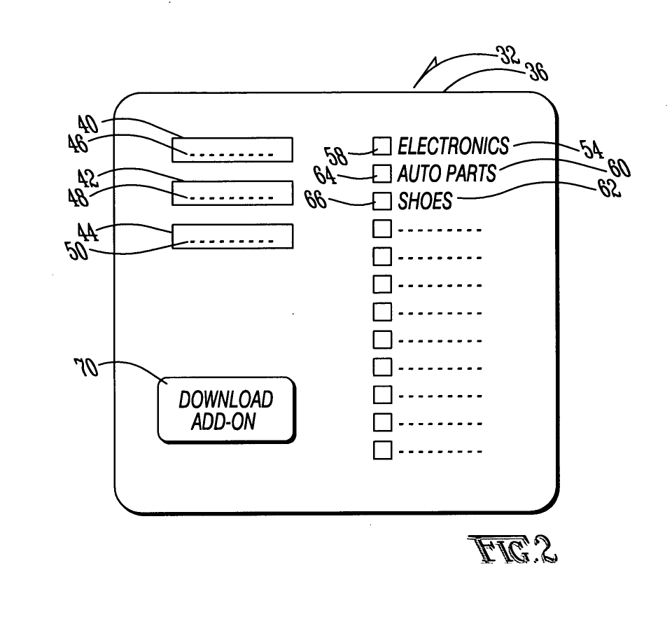

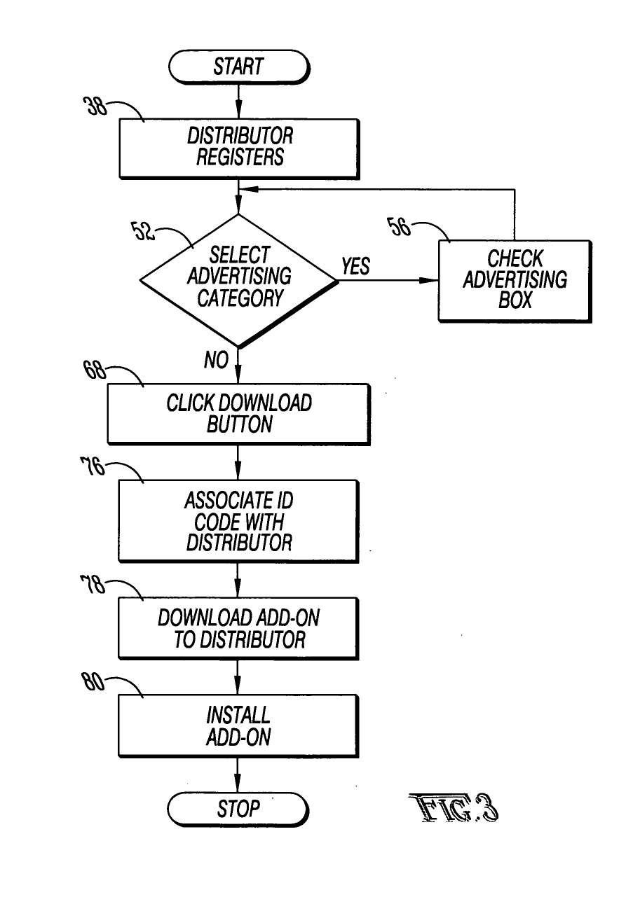

When it is desired to utilize the system (10) of the present disclosure, a distributor, preferably a person (not shown), utilizes a distributor computer system (22), such as a personal computer or a mobile computing device utilizing a processing unit (24). The distributor computer system (22) includes a browser (26). The distributor physically manipulates an input device such as a mouse (28) and/or a keyboard (30) to actuate the browser (26) to open an affiliate marketing website (32). (FIGS. 1-2). The affiliate marketing website (32) may be hosted by an affiliate network on an affiliate network server (34) in a manner such as that known in the art of affiliate website hosting. The website (32) comprises one or more web pages (36). As shown in FIGS. 2-3, the distributor registers (38) on the web page (36) by filling in fields (40), (42) and (44) requesting a username (46), password (48) and electronic mail message address (50). The distributor may then elect to select (52) an advertising category (54) by checking (56) the associated check box (58). The distributor may select (52) additional advertising categories (60) and (62) or specific advertisers by checking additional check boxes (64) and (66) as desired. Alternatively, the system (10) may automatically select (52) additional advertising categories (60) and (62). The distributor may visit the website (32) as needed to update the desired categories (54), (60) and (62). The distributor may receive periodic electronic mail messages providing the distributor with a hyperlink to the webpage (36) where the distributor may update the desired categories (54), (60) and (62).

Once the desired boxes (58), (64) and (66) have been selected (52), the distributor clicks (68) the download button (70) on the webpage (36) to obtain a browser add-on (72) for the distributor's chosen Internet browser. The browser add-on (72) is software that works with the extensibility of the browser (26). One example of such an add-on (72) is a Browser Helper Object used in association with Microsoft's Internet Explorer browser. The add-on may be of any type known in the art, and may be configured to operate in association with any desired type of browser. The add-on (72) binds to the browser (26) at runtime, acting as part of the browser (26). The add-on (72) is capable of accessing the document object model (not shown) of a webpage's source code, such as HTML, that is generated when the browser (26) loads a webpage (74). (FIGS. 1,2 and 4). The add-on (72) is also capable of inserting data into this object model, such as into HTML iframes, on the webpage (74).

When the distributor clicks (68) the download button (70) on the webpage (36), the content server (14), that may be associated with both the webpage (36) and its associated affiliate network server (34), associates (76) a unique identification code with the distributor's username (46) and password (48) and customizes the add-on (72) to include the identification code before downloading (78) the add-on (72) to the distributor's computer system (22). The distributor then installs (80) the add-on (72) in the distributor's computer system (22), which associates the add-on (72) with the browser (26) when the browser (26) is launched.

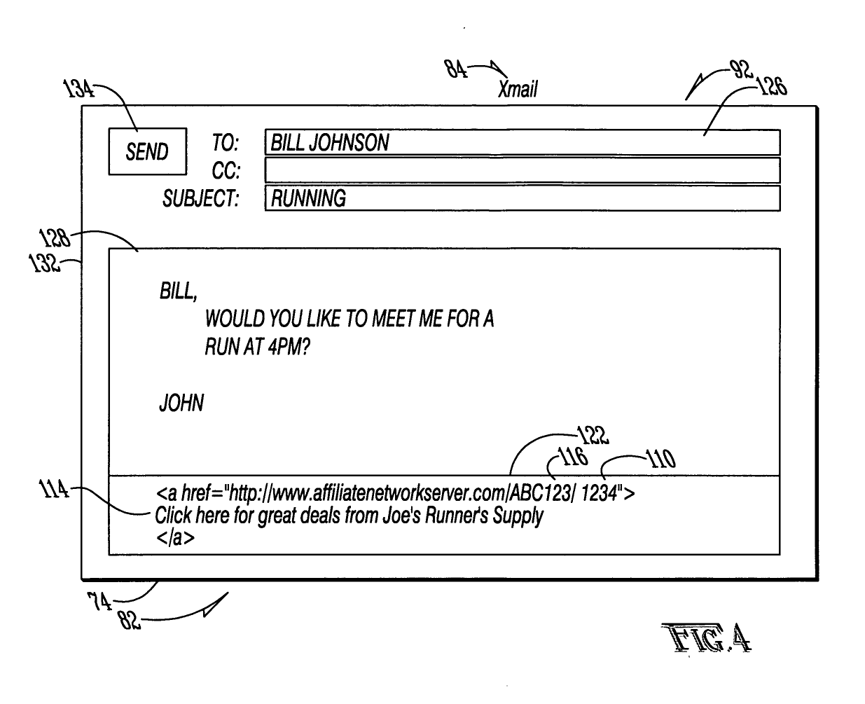

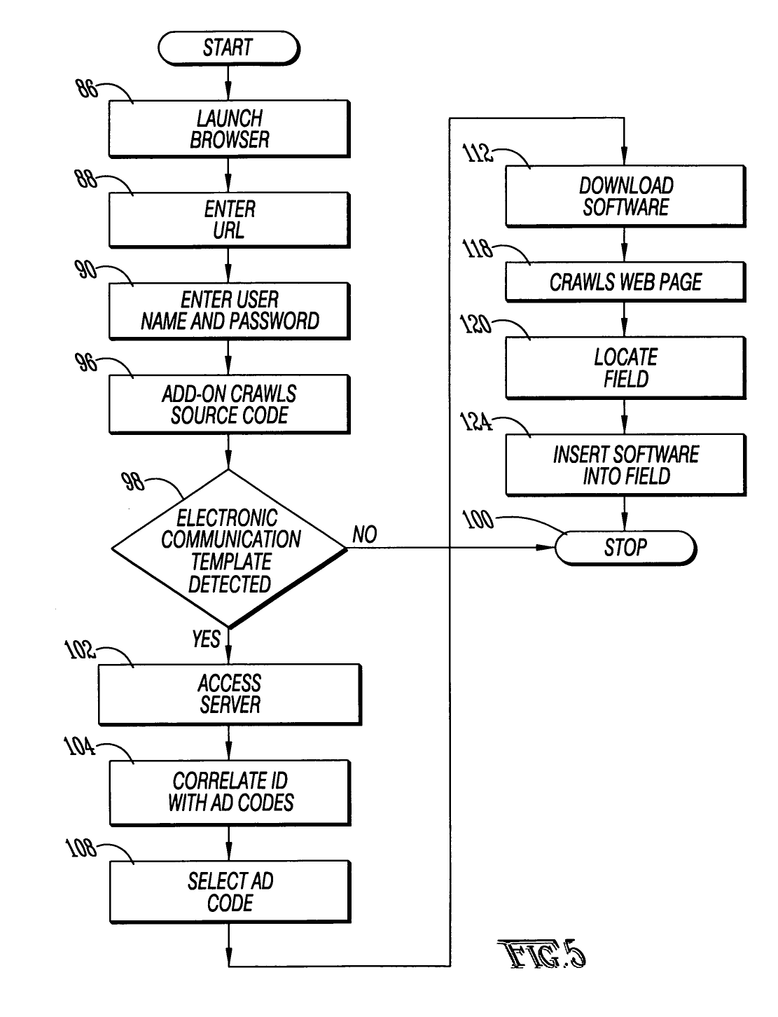

The webpage (74) shown in FIG. 4 is associated with a website (82) of a web mail client (84), such as Hotmail, Yahoo! Mail, Gmail, or any other web mail client known in the art. The distributor launches (86) the browser (26) and enters (88) the uniform resource locater (URL) into the browser (26) that displays the webpage (74) associated with the web mail client (84) (FIGS. 1, 4 and 5). The distributor enters (90) a predetermined password and username on the web mail client homepage (not shown) to display the webpage (74) with an electronic mail message template (92) on the monitor (94) of the distributor computer system (22).

The add-on (72) crawls (96) the document object model (not shown) of the source code, such as HTML, that is generated when the browser (26) loads the webpage (74). If the add-on (72) does not detect (98) an electronic mail message template (92), the add-on (72) stops (100). If the add-on (72) does detect (98) an electronic mail message template (92), the add-on (72) accesses (102) the remote server (18). Alternatively, the content server (14) may act as the remote server (18). The add-on (72) provides the remote server (18) with a unique identification code associated with the distributor. The remote server (18) correlates (104) the unique identification code with a database (106) of affiliate codes associated with predetermined advertisements, selects (108) an affiliate code (110) associated with a category (54), (60) or (62) previously selected by the distributor and downloads (112) an affiliate code, which may be a piece of software (114), such as HTML, containing the affiliate code (110) and the distributor's unique identification code (116) to the distributor's computer system (22). The add-on (72) crawls (118) the webpage (76) to locate (120) a predetermined field, such as a signature field (122), in the electronic mail message template (92) and inserts (124) the piece of software, such as the piece of software (114) into this field (122).

The electronic mail message template (92) includes an address field (126), message field (128), and the signature field (122). While the add-on (72) preferably inserts the piece of software (114) into the signature field (122), the add-on (72) may insert the piece of software (114) into any desired field. In the preferred embodiment, the piece of software (114) will be of the form below:

<a href=“http://www.affiliatenetworkserver.com/ABC123/1234”>
Click here for great deals from Joe's Runner's Supply
</a>

The distributor drafts (130) the electronic mail message (132) by filling in the fields (122), (126) and (128) in the electronic mail message template (92) and clicks the send button (134) to send (136) the completed electronic mail message (132) to one or more recipients in a manner such as that known in the art. If desired, prior to the electronic mail message being sent, the browser add-on (72) may provide the distributor with a confirmation box (not shown) identifying the advertisement associated with a piece of software (114). Prior to retrieving the piece of software (114), the browser add-on (72) may also provide the distributor with a selection box (not shown) providing the distributor with a plurality of advertisements from which the distributor may select. Once the distributor selects the desired advertisement, the browser add-on (72) retrieves and inserts the piece of software (114) corresponding to the selected advertisement.

The electronic mail message (132) moves from the distributor's computer system (22) through the Internet (20) using standard electronic mail transfer mechanisms to a recipient's computer system (138). In the preferred embodiment a recipient, preferably a person (not shown), uses the computer system (138), such as a personal computer including a processing unit (140) and an electronic mail client application (142), to receive (144) the electronic mail message (132). The recipient then physically manipulates a peripheral such as a mouse (146) or keyboard (148) to display the electronic mail client application (142) on a display, such as a monitor (150) and to cause the electronic mail client application (142) to open (152) the electronic mail message (132) in a manner such as that well known in the art. The received and displayed electronic mail message (154) includes the address field (156), message field (158) and signature field (160). The piece of software (114) sets the text (162) and a link, which may be a hyperlink (166) within the signature field (160).

Once the advertisement (164) has been displayed (168) on the monitor (150), the recipient has the option of taking a predetermined action, such as physically manipulating the mouse (146) or keyboard (148) to click (170) or otherwise select the hyperlink (166) associated with the advertisement (164). In response to the click (170), the hyperlink (166) directs the recipient's browser to send (172) a HTTP GET request to the affiliate network server (34). The affiliate network server (34) redirects (174) the recipient's browser (176) to the advertiser's website (178). Once the advertiser's website (178) is displayed on the recipient's browser (176), the recipient may take a supplemental predetermined action, such as making (180) a purchase (182) of an item (184), registering (186) with the advertiser's website (178) by filling out (188) registration information (190) with the advertiser's website (178), taking (192) a survey (194) by filling in (196) fields (198) on the advertiser's website (178), or any desired supplemental predetermined action.

When the affiliate network server (34) receives the HTTP GET request, the associated URL query string includes the distributor's unique identification code (116), or a similar code identifying the distributor. The use of the URL query string enables the distributor to be identified as the sender of the electronic mail message (154) that prompted the recipient to click on the advertisement (164). The affiliate network server (34) then compensates (200) the distributer in return for the recipient taking the predetermined action of clicking on the hyperlink (166). When the affiliate network server (34) redirects the recipient's browser (176) to the advertiser's website (178), the redirect includes the distributor's unique identification code (116), or a similar code identifying the distributor.

If desired, the affiliate network server (34) can be configured to compensate the distributor when the recipient takes a supplemental predetermined action, such as making a purchase (182), filling out (188) a registration, filling in (196) a survey (194) or taking any desired supplemental predetermined action. Identifying the distributer by the identification code (116), the advertiser associated with the advertiser's website (178) informs the affiliate network server (34) across the Internet (20) that a particular supplemental predetermined action has been performed by the recipient. Standard affiliate marketing techniques, such as those known in the art, are used to track the recipient's actions in association with the advertiser's website (178). The affiliate network server (34) then compensates (200) the distributer in return for the recipient taking the supplemental predetermined actions. The process repeats as the recipient continues to take additional supplemental predetermined actions.

The affiliate network server (34) compensates (200) the distributer by transferring funds from a financial account associated with the affiliate network server (34) to a financial account associated with the distributer. Alternatively, the affiliate network server (34) may initiate the forwarding of a check or other negotiable instrument to the distributor. In another embodiment, the affiliate network server (34) may compensate the distributor with goods or services, or with a credit or a gift certificate that the distributer may redeem at a later date.

Unlike prior art systems involving an advertiser hiring a marketing company to randomly send out bulk electronic mail messages to unknown recipients on a purchased list, the present disclosure allows the advertiser to target advertisements not only to a specific audience, but to provide the potential customer a frame of reference for the advertisement in the form of a referral from the distributor who has a pre-existing relationship with the potential customer.

The distributor may send the electronic mail message (132) to a first recipient computer system (138) and later send the same or different electronic mail message (132) to a second recipient computer system (202) across the Internet (20) to allow the second recipient to use a mouse (204) or keyboard (206) to open the electronic mail message (132) and display the electronic mail message (132) on the second recipient's display (208) in a manner such as that described above.

A second distributor (not shown) may utilize a second distributor computer system (210) to access the content server (14) and, using the process described above, retrieve the piece of software (114) from the content server (14), and insert the piece of software (114) into the signature field (114) of an electronic mail message (132). The second distributor may send electronic mail messages (132) to various electronic mail message recipients in a manner such as that described above. The second distributor may use the second distributor computer system (210) to send the electronic mail message (132) to the recipient computer systems (138), (202), or any other recipient computer systems, such as (212), (214) and (216). Any additional number of distributors may use any additional number of distributor computer systems (218), (220) and (222) and may all utilize the same server system (10) or different systems (not shown). In the preferred embodiment, there are at least one hundred, preferably at least one thousand and, most preferably, at least ten thousand simultaneous distributor systems operating to distribute the advertisements associated with the content server (14) and preferably at least one thousand, more preferably at least ten thousand and, most preferably, at least one hundred thousand recipient systems receiving electronic mail messages (132) incorporating the advertisements (164) associated with the content server (14). Of course, as known in the prior art, the content server (14) and database server (16) may either be single servers or may be a series of servers utilized to accomplish the functionality described above.

Although the subject matter disclosed has been described with respect to a preferred embodiment thereof, it is to be understood that it is not to be so limited since changes and modifications can be made therein which are within the full, intended scope of this disclosure as defined by the appended claims.

What is claimed is:

1. A system comprising:
(a) a server;
(b) an electronic mail message template;
(c) a browser that displays the electronic mail message template;
(d) a browser add-on configured to bind to the browser at run time, detect the presence of the electronic mail message template and, in response, automatically insert an affiliate code and a distributor code into the electronic mail message template;
(e) wherein the affiliate code is configured to display a link to a predetermined website when an electronic mail message created with the electronic mail message template and containing the affiliate code is opened; and
(f) wherein the distributor code is configured to identify the distributor of the electronic mail message to the server in response to a recipient taking a predetermined action associated with the affiliate code.

2. The system of claim 1, the predetermined action is clicking on the link.

3. The system of claim 2, wherein the server is configured to compensate the distributor in return for the recipient clicking on the link.

4. The system of claim 1, the predetermined action is performing a supplemental predetermined action on the predetermined website.

5. The system of claim 1, wherein the server is configured to compensate the distributor in return for the recipient performing a supplemental predetermined action on the predetermined website.

6. The system of claim 5, the supplemental predetermined action is making a purchase from the predetermined website.

7. The system of claim 1, further comprising an affiliate network server configured to compensate the distributor in return for the recipient performing a supplemental predetermined action on the predetermined website.

8. The system of claim 7, the supplemental predetermined action is registering on the predetermined website.

9. The system of claim 1, wherein the add-on is configured to crawl the electronic mail message template to locate a signature field.

10. The system of claim 9, wherein the add-on is configured to insert the affiliate code into the signature field.

11. A system comprising:
(a) a webmail client provided with an electronic mail message template;
(b) a browser configured to display the webmail client;
(c) a browser add-on configured to bind to the browser at run time, crawl the webmail client for the electronic mail message template, and insert advertising associated with a distributor into the electronic mail message template;
(d) a server configured to receive a distributor code associated with the distributor of an electronic mail message created with the electronic mail message template; and
(e) wherein the server is configured to compensate the distributor in return for the recipient taking a predetermined action associated with the advertising.

12. The system of claim 11, the predetermined action is clicking on a link associated with the advertising.

13. The system of claim 11, wherein the electronic mail message is configured to display a link to a predetermined website when the electronic mail message is opened.

14. The system of claim 13, the predetermined action is performing a supplemental predetermined action on the predetermined website.

15. The system of claim 13, wherein the server is configured to compensate the distributor in return for the recipient performing a supplemental predetermined action on the predetermined website.

16. The system of claim 15, the supplemental predetermined action is registering with the website.

17. A method comprising:
(a) providing a browser;
(b) providing a browser add-on that binds to the browser at run time;
(c) launching a webmail client within the browser to display an electronic mail message template;
(d) crawling the electronic mail message template with the browser add-on to find a predetermined location;
(e) inserting affiliate code associated with a distributor at the predetermined location;
(f) sending an electronic mail message created with the electronic mail message template and containing the affiliate code from the distributor to a recipient;
(g) executing by a recipient of the electronic mail message a predetermined action associated with the affiliate code contained within the electronic mail message; and
(h) compensating the distributor in response to execution of the predetermined action by the recipient.

18. The system of claim 17, the predetermined action is clicking a link within the electronic mail associated with the affiliate code.

19. The system of claim 17, further comprising;
(a) executing by the recipient a supplemental predetermined action; and
(b) providing additional compensation to the distributor in response to the execution of the supplemental predetermined action

20. The system of claim 19, the supplemental predetermined action is the recipient making a purchase from a website associated with the affiliate code.
